(19) United States
(12) Patent Application Publication
(10) Pub. No.: US 2002/0056109 A1
(43) Pub. Date: May 9, 2002

(54) Method and system to provide a personalized shopping channel VIA an interactive video casting system

(76) Inventor: Mai-lan Tomsen, Seattle, WA (US)

Correspondence Address: Dennis M. de Guzman, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/792,075

(22) Filed: Feb. 22, 2001

Related U.S. Application Data
(60) Provisional application No. 60/220,798, filed on Jul. 25, 2000.
(60) Provisional application No. 60/236,422, filed on Sep. 28, 2000.

(51) Int. Cl. G06F 3/00

(52) U.S. Cl. 725/60

(57) ABSTRACT

A personalized shopping channel is made available via an interactive video casting system. The personalized shopping channel can provide links or access to shopping sites based on user preferences. For example, user profile information is correlated with merchant data or product data to select merchants or products that are relevant to the user. This allows the personalized shopping channel to conveniently provide the user with access to these types of merchants, while filtering out less relevant merchants.

### CROSS-REFERENCE TO RELATED APPLICATIONS

The present application claims the benefit of U.S. Provisional Patent Application Ser. No. 60/220,798, filed Jul. 25, 2000, entitled “METHODS AND SYSTEMS FOR COMMERCE VIA INTERACTIVE TELEVISION” and U.S. Provisional Patent Application Ser. No. 60/236,422, filed Sep. 28, 2000, entitled “METHODS AND SYSTEMS FOR COMMERCE VIA INTERACTIVE TELEVISION,” both of which are incorporated herein by reference.

### TECHNICAL FIELD

This disclosure relates generally to commerce over a data communication network, and more particularly but not exclusively, to transaction opportunities involving goods and/or services via an interactive video casting network having connectivity to the data communication network.

### BACKGROUND

An important business element in the production and distribution of television programming is revenue received from manufacturers and service providers who pay to advertise and sell their products. The survival of a television program is heavily dependent on the advertising revenue that can be realized from the television program. Advertisers in turn rely on the ability of the television program to draw users who then become potential purchasers of the advertised products. An effective commercial is one that captures the viewer's attention in a lasting manner and that ultimately results in the purchase of goods and/or services.

Targeting potential customers through television advertising or other programming has its limitations. For example, the user may lack the motivation to travel to a store or to make a telephone call to purchase the advertised product. In some cases, the user must independently access the World Wide Web via the Internet to purchase an advertised product from a merchant's web site. Providing purchasing opportunities through a web site has proven to be less than successful for merchants in some instances, since the user has to navigate through web pages, the user's transaction history is sometimes difficult or cumbersome to track, advertisements targeted to the user are not always readily available, etc.

Also, a variety of people from different purchasing demographics may be watching the same television program or viewing the same web site. Advertising aimed at one particular group may be uninteresting or even displeasing to another group. For instance, television “shopping channels” are typically targeted to general audiences, and so they are often useless to many viewers who have no interest in the products being advertised in the program. When a shopping channel does not meet the needs or interests of the user, this can result in “channel surfing,” inefficient marketing, and viewer inconvenience. A potential consumer can easily be discouraged from making a purchase if that consumer is presented with a myriad of different (and perhaps unfamiliar) stores, products, or shopping sites to choose from, coupled with inconvenient mechanisms to perform a purchase experience once an item of interest to the viewer is identified. These drawbacks reduce the effectiveness of shopping channels, or make the purchase experience less appealing to users. Accordingly, more effective techniques are needed in the presentation of shopping opportunities to potential consumers.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIGS. 1-3 show examples of interactive video casting systems that can implement an embodiment of the invention.

FIGS. 4-9 illustrate examples of the creation of a user profile for a personalized shopping channel for the interactive video casting systems of FIGS. 1-3 according to embodiments of the invention.

FIGS. 10-12 illustrate example uses of an embodiment of a personalized shopping channel for transactions that can be conducted via the interactive video casting systems of FIGS. 1-3.

FIGS. 13-14 illustrate an example of a promotion that can be provided in conjunction with a personalized shopping channel.

### DETAILED DESCRIPTION OF THE ILLUSTRATED EMBODIMENTS

Embodiments of a method and system to provide a personalized shopping channel are described herein. As an overview, an embodiment of the invention provides a personalized shopping channel that is available via an interactive video casting system. The personalized shopping channel can provide links or access to shopping sites based on user preferences. For example, user profile information (also referred to herein as “user profile” or “profile”) may indicate that a user or viewer is a frequent buyer of children's clothing. The personalized shopping channel can display a list of merchants selected by correlating this profile information with data of merchant outlets for children's clothing, thereby resulting in a shopping channel that conveniently provides the user with access to these types of merchants that have been associated to the user. In an embodiment, access and/or links to merchants can also be correlated to other tools or interfaces, such as the user's electronic calendar, so that merchant information relevant to calendar entries can be presented to the user.

In accordance with an embodiment of the present invention, the stores that are displayed to the user in a personalized shopping channel are the stores that map explicitly or implicitly to the user's preferences. Stated in another way, the shopping channel is personalized to provide access to shopping sites and/or advertising that correlates with a user's personalization profile, such that non-relevant merchants or advertisements can be excluded. A profile may include data that is explicitly provided by the user and/or implicit data. For example, user profile information explicitly provided by the user can include, but is not limited to, information from questionnaires or profiles filled out by the user and/or wish lists made by the user. A wish list can include products that the user would like to purchase for gifts or for personal use, for instance.

Examples of implicit data may include information about a user's past shopping behavior (such as click stream, transaction behavior, viewing habits, and the like) or data obtained from collaborative filtering. Data from collaborative filtering can include information about products purchased by people of similar profiles and/or purchase habit data that is gathered or extrapolated.

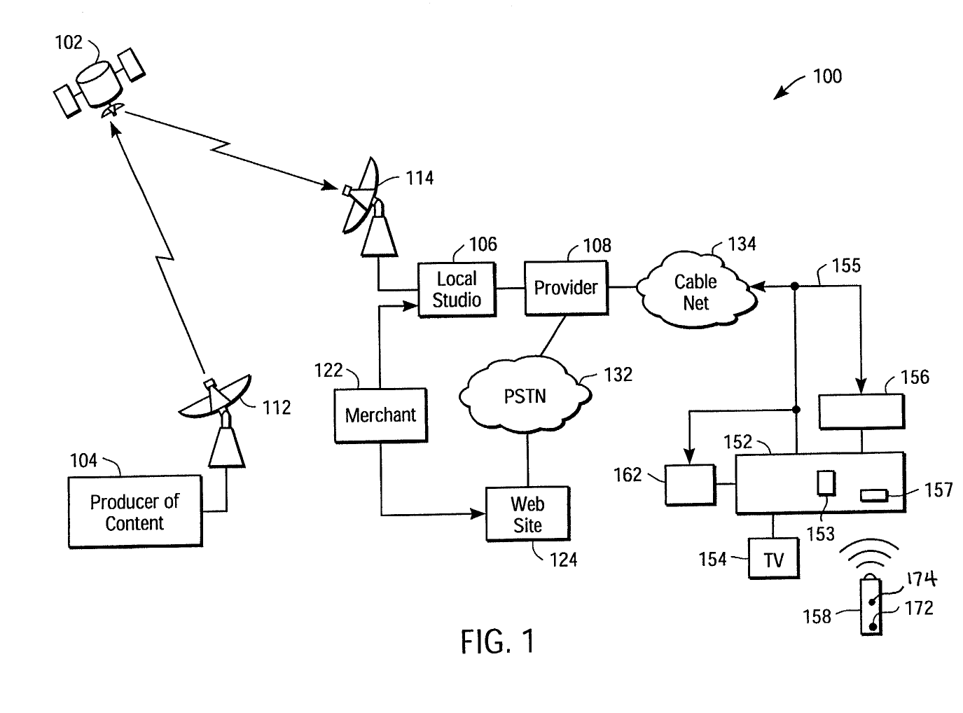

In the description herein, numerous specific details are provided, such as the description of system components in FIGS. 1-3, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

FIG. 1 shows an example arrangement of an interactive video casting system 100 in accordance with an embodiment of the invention. A production company 104 produces programming content for transmission to viewers. The transmission is sent via satellite transmission transceiver 112 over an uplink channel to a satellite 102. The satellite 102 then transmits the programming content over a downlink channel to a local studio 106. The local studio 106 can insert additional programming (e.g., regional programming) and/or advertisements as needed into the programming content. The content with the insertions is then transmitted from the local studio 106 via a satellite transmission transceiver 114 to a cable service provider 108. In an embodiment, the television program may be downloaded to a receiving station, such as a head-end (H/E) of the cable service provider 108, rather than or in addition to the local studio 106. A reverse channel from the cable service provider 108 to the local studio 106 is provided so that the local studio 106 can insert additional programming content and feed the television signal back to the cable service provider 108. The cable service provider 108 then delivers the television signal over a cable network 134 to cable subscribers.

The cable network 134 is provided by the cable service provider 108 to distribute the programming content to cable subscribers. A set top box (STB) 152, located on the premises of a cable television subscriber, receives the programming content or television signal, and delivers the television signal to the subscriber's television set 154. Alternatively or in addition, the television signal can be broadcast over a wireless medium and received by a traditional aerial antenna or by a satellite dish, and then delivered to the set top box 152. Alternatively or additionally, features and functionality of the set top box 152 may be integrated into a type of advanced television or other display device.

Moreover, embodiments of the invention can use other types of broadcast media, including but not limited to, digital cable systems, satellite, very-high-data-rate digital subscriber line (VDSL), web casts, and the like. The features provided by the television set 154 can also be provisioned, in one embodiment, by a personal computer (PC) suitably configured with an adapter to convert television signals into a digitized format, and then to deliver the television signals to the video portion of the computer for display. It is noted that the invention is not limited to any one configuration of display hardware, as embodiments of the invention will work equally well using alternative reception and display arrangements.

In accordance with an embodiment of the invention, a connection to a communication network is provided for the cable subscriber. In one embodiment, the connection can be made via a cable modem 156 over a bi-directional communication link 155 to a cable modem termination system within the cable provider's 108 equipment. The connection continues to a data communication network, such as the Internet, by way of a public switched network (PSTN) 132. The PSTN network 132 is provided herein as an example, and it is understood that other types of networks may be used for connectivity to the Internet. A cable modem arrangement can be used because of its high bandwidth capability. In situations where some cable companies are not equipped to provide cable modem service to their customers, various other arrangements can be made. For example, a conventional modem connection can be used to access the Internet over a telephone line. As another example, Internet access can be gained over a DSL connection or an integrated services digital network (ISDN) connection using a telephone line. Wireless systems are also available for providing Internet access. In one embodiment, downstream data transmission can occur via cable or satellite, and upstream data transmission can occur via a telephone line.

It is noted that the Internet is chosen as an example of a data communication network because it is a well-established network, and connectivity to the Internet is easily made. However, it is noted that a global communication network, such as the Internet, is not required to practice other embodiments of the invention. A locally provided and maintained communication network may be used in an embodiment.

Continuing with FIG. 1, the set top box 152 can include a transceiver 157, such as an infrared (IR) or radio frequency (RF) transceiver, that can exchange signals with a remote control unit 158 or other user input device. The set top box 152 can be a component that is separate from the television set 154 as shown in FIG. 1, or its features can be built into circuitry of the television set 154 (e.g., an interactive television set). The set top box 152 enables a viewer to select a television program to view and then delivers the television program to the television set 154. A storage unit 162 can also be coupled to or be a part of the set top box 152. The storage unit 162 can comprise a machine-readable storage medium such as a cache, buffer, memory, diskette, compact disk, tape, or the like and their associated hardware, in one embodiment. In another embodiment the storage unit 162 can include a video cassette recorder (VCR). In another embodiment, the storage unit can include a hard disk such as a digital or personal video recorder (DVR or PVR).

As noted above, the local studio 106 can insert additional programming into the received transmission, for example, to provide cable content that includes locally provided channels. The programming is then distributed to customers over the cable network 134. In addition to local program insertion, the local studio 106 can insert advertising content. Product supplemental information relating to the advertising for participating merchants 122 can also be inserted. Product supplemental information can include information relating to the goods or services being advertised in the commercial. In addition to goods and services, coupons and other information services can be made available to the viewer, which in one embodiment can be obtained via the merchant's 122 web site 124 on the Internet. Triggers, such as Advanced Television Enhancement Forum (ATVEF) triggers, which are related to the web site 124 and/or to its contents, can be continuously updated as the television broadcast is being received.

In accordance with an embodiment of the invention, a participating merchant list 153 may be maintained. As the name implies, this list permits participating merchants 122 to provide their product supplemental information to the viewer. The participating merchant list 153 may be provided to and stored in the set top box 152. Alternately or additionally, the participating merchant list 153 may be stored at a head-end or other system of the cable service provider 108, or at a third party system. In this embodiment, the participating merchant list 153 may operate as a “white” list which allows transmission of triggers from authorized merchants and filters out other triggers. In another embodiment, a “blocked” or “black” list may be maintained at the set top box 152 or elsewhere. Such a blocked list filters out undesirable triggers and may be created and/or maintained by the cable service provider 108. Alternately or additionally, such a blocked list may be edited by an end user.

Various techniques for carrying the product supplemental information can be used. For example, triggering, announcement, or resource information can be included and sent using the ATVEF standard, in a manner known by those skilled in the art. For instance, a uniform resource locator (URL) address can be embedded in the broadcast stream. Other standards that may be used include triggering mechanisms from Wink and WorldGate. Another technique is to embed code or a script in the stream that runs on the client (e.g., at the set top box 152) to provide the information and/or purchase experience.

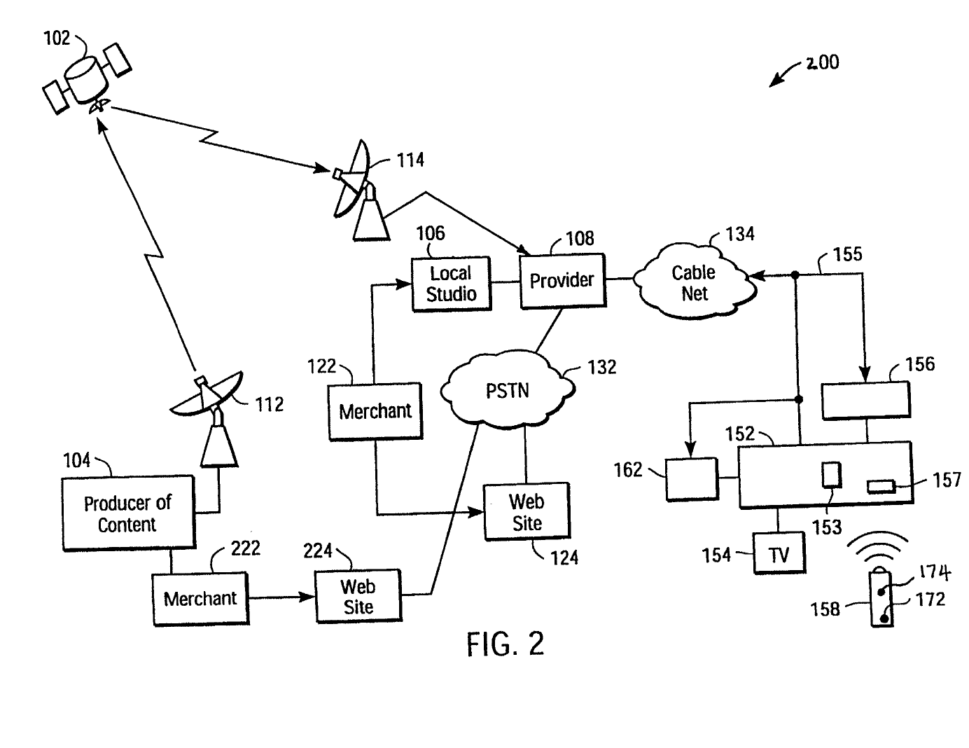

As noted above, the triggers, resources, or announcements can be inserted by the originating broadcaster 104, a local broadcaster 106, or by the cable system operator 108. FIG. 2 shows another example of an interactive video casting system 200 and illustrates another point of insertion of the product supplemental information. Here, a merchant 222, operating a web site 224, is located such that commercial insertion is made prior to the uplink transmission to the satellite 102.

As noted above, Internet access is not necessary to practice the invention. A locally provided network may be within the scope of the invention as claimed. The cable provider 108 can supply the foregoing features, for example, by providing a web site or “walled garden” that is accessed by its subscribers. In such a case, the cable provider 108 serves as an intermediary and submits the purchases to the actual merchants 122 or 222.

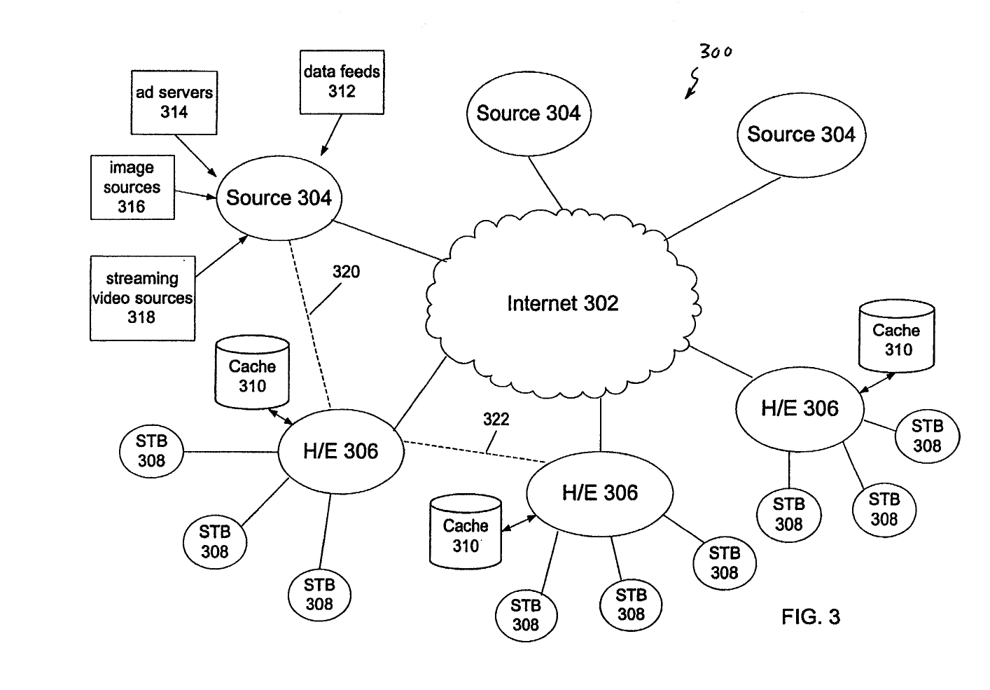

FIG. 3 shows another example of an interactive video casting system 300 for distributing Internet content in addition to television content. The system 300 can be similar to or combined with the systems 100 and 200 shown in FIGS. 1 and 2, respectively. In accordance with an embodiment of the present invention, the system 300 can be integrated with a cable television distribution system. The system 300 includes an Internet 302, a plurality of content sources 304, a plurality of distribution centers (depicted as the head-ends or H/Es 306), and a plurality of client terminals 308 (depicted as set top boxes). In addition, a content source 304 is depicted as receiving data from data feeds 312, advertisement servers 314, image sources 316, and streaming video sources 318.

The plurality of content sources 304 is coupled to the Internet 302. For example, a content source 304 may comprise a web site portal such as Go2Net.com, or a news web site such as CNN.com, or other types of sources. Each content source 304 may have various data feeds 312, servers 314, and sources 316/318 coupled to it.

For example, news or stock quote feeds 312 may be fed into the content source 304. Servers 314 may provide advertisements for insertion into multimedia content delivered by the content source 304. Sources 316/318 may provide images 316, streaming video 318, and other content to the content source 304. Various other feeds, servers and sources may also be coupled to the content source 304 of FIG. 3, or coupled to the production company 104, cable network 134, web sites 124 and 224, or to other components of the systems shown in FIGS. 1 and 2.

The Internet 302 comprises a network of networks and is well known in the art. Communications over the Internet 302 can be accomplished using standard protocols such as transmission control protocol/internet protocol (TCP/IP), hypertext transfer protocol (HTTP), file transfer protocol (FTP), or other protocols. The Internet 302 is coupled to the plurality of distribution centers 306, and each distribution center 306 is in turn coupled to a plurality of client terminals 308, which may comprise a set top box, a PC, an interactive television set, or another type of communication device or display device.

In alternative or in addition to the Internet 302 being used to distribute multimedia content from the content sources 304 to distribution centers 306, communications channels or networks 320 apart from the Internet 302 may couple one or more content sources 304 to one or more distribution centers 306. One example of such an alternate path for communications is illustrated by a first dashed line 320 in FIG. 3. Alternately or additionally, peering connections may exist between distribution centers 306. One example of such peering is illustrated by a second dashed line 322 in FIG. 3. Other configurations are also possible and are included within the scope of the present invention.

Caches 310 may be provided at (or coupled to) the distribution centers 306. Such caches 310 may be used to increase the performance in the delivery of multimedia content to the client terminals 308. For example, larger files for video and other high bandwidth content may be stored in such caches 310, which may be closer to the client terminals 308 than to the content sources 304. In addition, reliability and guaranteed bandwidth may be provided because the Internet 302 is not in-between such caches 310 and the client terminals 308.

In accordance with one embodiment of the invention, different or multiple portals may be used to access the information provided through the interactive video casting systems of FIGS. 1-3, based on the type of client terminal being used by the end user. That is, for example, a television portal may be provided for an end user that uses the television set 154 to access the information. A PC portal may be provided for an end user that uses a PC to access the information. Portals can be provided for end users that use cellular telephones, PDAs, audio devices, and the like to access the interactive video casting systems of FIGS. 1-3.

Such portals may be provided in several possible ways. In one embodiment, the client terminal (e.g., the end user's display device or audio device) can be suitably configured with an adapter that includes hardware and software. The adapter converts the television signals, the Internet or web page content, or other information provided from the interactive video casting system into a digitized format or other format that is compatible with the operational features of the client terminal.

In another embodiment, the cable provider 108 can deliver signals having different formats to the various client terminals, with the client terminals not necessarily having special adapters. Therefore, as an example, the cable provider 108 or other party can generate/deliver information (e.g., television programming, web page content, and the like) having a format that is compatible for end users that receive the information via the television set 154. The cable provider 108 or other party can also generate/deliver the same information (e.g., simultaneously with the television portal on the same communication link, separately on a different communication link, on-demand independent of the television portal, and the like) using a format that is compatible with end users that receive the information via PCs, PDAs, cellular telephones, and the like. Thus, the term “interactive video casting system” is used to describe generally a system that can deliver video information over any network and any network-compatible device by broadcasting, multicasting, or unicasting. An “interactive television system” is one type of or one means of access to an “interactive video casting system.”

Via the interactive video casting systems of FIGS. 1-3, a personalized shopping channel according to various embodiments of the invention can be implemented in several forms or combinations thereof. In one embodiment, the personalized shopping channel can be a dedicated television channel that displays television programs/broadcasts, television commercials, and advertising that are correlated to the user's profile. As an example, the cable service provider 108, the local studio 106, or other party can identify or store television commercials, segments of television broadcasts (such as clips of segments that describe or sell jewelry on QVC), web site URLs or hypertext links, and the like, and then transmit such information in the television channel that is specifically dedicated for that user.

In another embodiment, the personalized shopping channel can be a television channel that can display hypertext links, merchant lists, storefronts, logos, or other merchant information that, if clicked by the user using the remote control unit 158, takes the user's set top box 152 to the web site 124, merchant's television channel, or other location where the user can conduct a purchase. An example of this type of personalized shopping channel is somewhat analogous to an electronic program guide channel that “scrolls” information showing the programs to be aired on each television channel. With the personalized shopping channel, however, merchant information rather than channel programming information is displayed.

As yet another embodiment, the personalized shopping channel can comprise a web page or web site that displays merchant content/information (e.g., hypertext links to merchant web sites, banner advertisements, and the like) that map to the user's profile, with the personal shopping channel web site capable of being accessed via a conventional PC, via the television set 154, or via some other portal or combinations thereof. It is to be appreciated that these various embodiments of the personalized shopping channel are illustrative, and that their features can be suitably modified or combined to provide other embodiments of the personalized shopping channel.

FIGS. 4-9 demonstrate examples of the creation of a user profile using the interactive video casting systems of FIGS. 1-3 according to an embodiment of the invention. Once the user profile is created, a personalized shopping channel can be provided to the user that corresponds to the user profile (e.g., the user can be signed up for a personalized shopping channel). Users can be signed up for the shopping channel service in a variety of ways.

FIG. 4 shows an example of a personalized shopping channel 402, as displayed on the television set 154. The example shows how the personalized shopping channel 402 may appear to the viewer when the viewer has just “tuned to” the personalized shopping channel 402 for the first time. At this initial stage, the personalized shopping channel 402 displays a plurality of merchants 403, such as a merchant list, logos, hypertext links to their web sites, links to their television channels, television commercials, banner advertisements, and the like. Because the viewer is a new user of the personalized shopping channel 402, the displayed merchants 403 can have little or no correlation to that specific viewer's profile at this point.

If, however, the viewer is a registered user or customer of a particular merchant (such as Amazon.com), then that merchant can be one of the listed merchants 403 that has a sub-channel or other link available via the personalized shopping channel 402. Thus, the viewer can select and access that merchant at 404 (using the remote control unit 158, for example). It is understood that the viewer can also select any of the other listed merchants 403 without necessarily having a previous account with such a merchant.

In accordance with an embodiment of the invention, the merchants 403 that are available in the personalized shopping channel 402 can include merchants on the participating merchant list 153 (e.g., the “white” list). Such merchants can collect profile information about a particular customer/viewer, and then make such profile information available for use in customizing the personalized shopping channel 402 to that viewer.

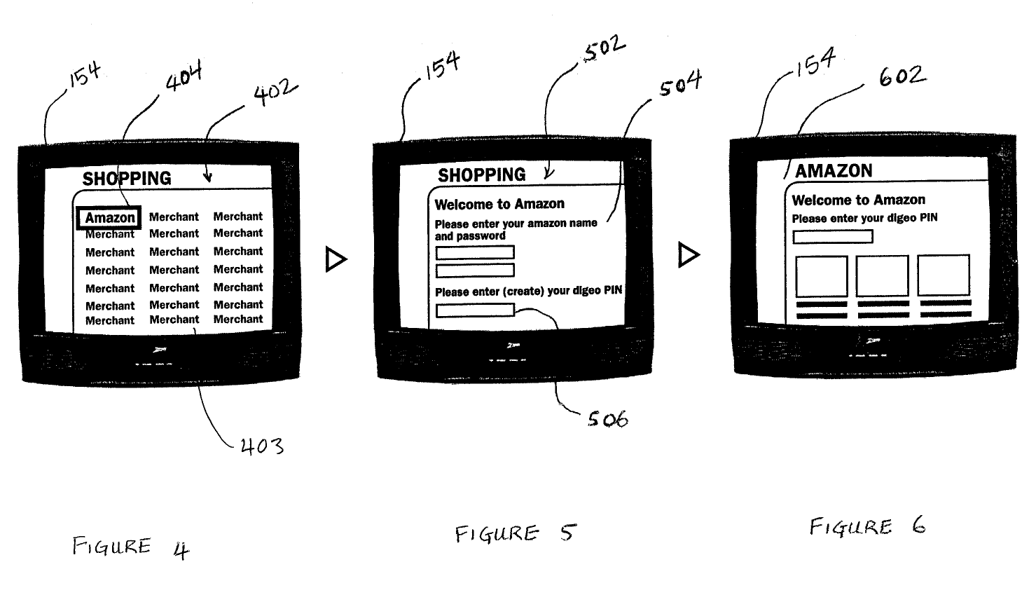

FIG. 5 illustrates that when the first-time user selects a store or a merchant at 404, the cable service provider 108 (or other party) links the user's set top box 152 to the merchant's web site, television channel, broadcast segment, or other access point 502. In accordance with an embodiment of the invention, the user can be prompted at 504 to enter user's credentials, if the user has not previously used such credentials in the personalized shopping channel 402. The user can then enter the appropriate information or otherwise log in to be a registered visitor of the merchant's site, or the user can enter a previously acquired name and password (such as the user's existing name and password for Amazon.com).

In an embodiment, the prompt 504 can be generated by the particular merchant, by the cable service provider 108, or by another party that provides access to the personalized shopping channel 402. By entering information in response to the prompt 504, information usable for creation of a profile for the user can be obtained. In addition in FIG. 5, the user can be prompted at 506 to enter or create a personal identification number (PIN) 506 or other identification information. From that point on, as shown in FIG. 6, when a web site 602 (or any merchant web site 122) is visited by the user and the PIN is entered, the user profile is activated, and all relevant interaction with the web site 602 is tracked and entered as appropriate into the user profile. Also, once the user enters the user's PIN on the merchant web site 602, information such as stored addresses and shipping information can be recalled and used for a transaction.

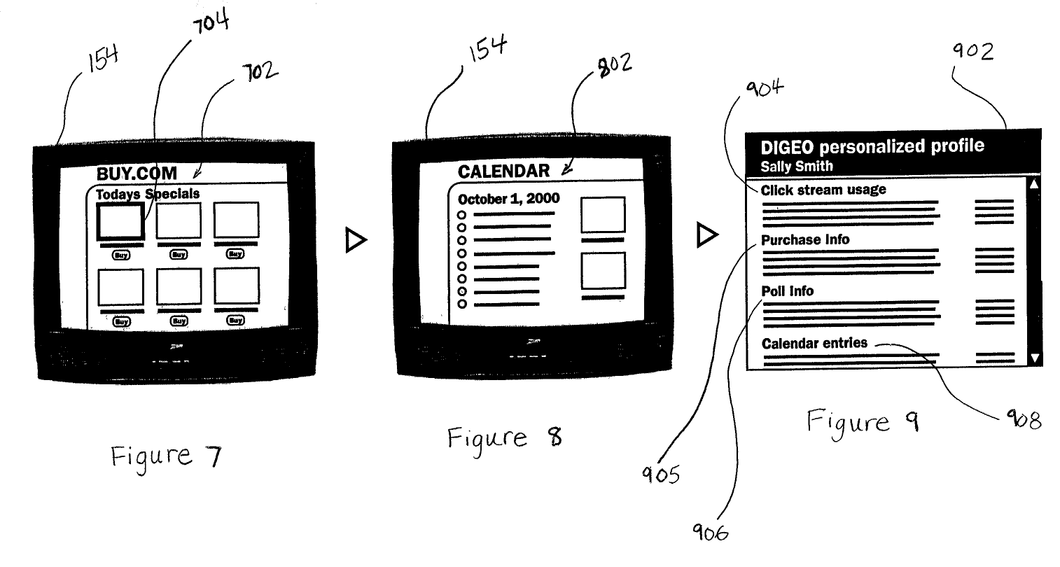

FIGS. 7-8 illustrate other examples of how information about the user can be tracked and placed into the user profile. In FIG. 7, an interface 702 to a purchase experience is displayed on the television set 154 for viewing by a user. The interface 702 can include, but is not limited to, movies, television commercials, music videos, sporting events, situation comedy shows, special interest shows, home shopping shows, or other types of programming that can provide the user with a purchase opportunity. Other examples of the interface 702 include a web site, a web page, a web portal, a user calendar, a user address book, a user recipe book, or other types of tools, interfaces, services, and the like that can be provided by the cable service provider 108, the merchant 122, or other party.

Continuing with FIG. 7, a purchase made by a user through the interface 702 provides data that contributes to the user profile. For example, if a purchase 704 is golf-related, the user's interest in golf is noted in the user profile. In addition to the type of product purchased, the data related to the purchase can include, but is not limited to, price range, timing of the purchase or other information related to any particular merchant or merchant category, such as merchant name, geographic location, type of products/services sold, and the like.

FIG. 8 shows the user's electronic calendar 802 displayed on the television set 154, and illustrates yet another type of data that can be included in the user profile. For example, an entry in the user's calendar 802 for a family member's birthday is time-dependent information that can be relevant to the user's purchasing habits. The user profile may be updated to include this birthday information, such that the birthday information in the profile can be correlated with merchant and product data to provide merchant links, commercials, promotions, and the like (displayed on the user's personalized shopping channel 402) that are related to gifts and birthday services.

FIG. 9 shows an embodiment of the user profile 902 that contains the information from the transactions illustrated in FIGS. 7 and 8. Purchase information corresponding to FIG. 7 is shown at 905, and calendar entries corresponding to FIG. 8 is shown at 908.

The profile 902 can also include information 904 about click stream usage. Such click stream usage information 904 includes implicit data that can be accumulated into the user profile 902 as the user participates in or uses the interactive video casting system of FIGS. 1-3. For example, if the user purchases many items related to golfing, the user profile 902 may be updated to note the user's interest in golf items based on the golf web sites visited by the user. Further, if the user watches several golf related television programs, the user profile 902 may be updated to note the user's interest in golf. Thereafter, golf merchants can be included among the merchants 403 that are displayed to the user in the personalized shopping channel 402.

In accordance with embodiments of the invention, several techniques can be used to gather implicit information for the user profile 902. For example, cookies may be used to gather user profile data; pay-per-view information or other user-viewing information can be logged that tracks the user's viewing habits; merchants 122 or other entities can exchange or provide customer information; and the like.

The user profile 902 can also include information 906 obtained from surveys or polls filled out by the user. Surveys can be obtained from the user in a variety of ways. For example, a user may voluntarily fill out a survey when the user signs up for service with the cable service provider 108 or in exchange for free online services offered periodically in connection with a specialized channel.

It is to be appreciated that the user profile 902 is not limited to the information illustrated in FIG. 9. The user profile 902 can include any type of information relevant to a user's purchase preferences or experience. Other examples of information in the user profile 902 may include wish lists (personal or for other persons), data from collaborative filtering, and/or data related to any other interaction with the services provided by the cable service provider 108 or other party. Data from collaborative filtering can include information about purchases made by people with similar profiles as the user and/or profiles of people having purchase habits similar to that of the user. Collaborative filter techniques known by those skilled in the art may be used in one embodiment to gather such information and to use such information to select appropriate merchants for display in the personalized shopping channel 402.

In addition to purchase-related data shown in FIG. 9, the user profile 902 may include data indicative of personal interests, income level, gender, age, or previous television program viewing history of the user. In an embodiment, some of these user profile elements may be explicitly provided by the user when the user establishes or modifies the user profile 902 in conjunction with use of the user's interactive television account. For example, users may enter personal interests such as tennis, hiking, and computer games, as well as other information when using their interactive television account. Such an account may be established when subscribing to the cable service provider 108, purchasing items from the web site 124 of the merchant 122, or in other ways.

According to an embodiment of the invention, a single user may have more than one profile to allow for different styles of shopping. For example, there may be a personalization profile for gifts as well as a separate personalization profile for personal shopping. Further, a user can have separate profiles for different shopping categories, such as clothes, electronics, children's goods, or home furnishings. These various profiles can be used for a single personal shopping channel or for multiple personal shopping channels, either of which in turn may be used by single users or multiple users. If multiple users are sharing a single category of personalized shopping channel, such as a shopping channel customized to golf, then the PINs of the different users can be used to distinguish one user from another during log on, thereby uniquely customizing the purchase experience for each individual user.

The user profile 902 can be stored in the set top box 152, in the remote control unit 158, in another device coupled to the television set 154, in the head-end 306, in one or more servers in the systems shown in FIGS. 1-3, or in any suitable combination of these locations or other locations having a machine-readable storage medium capable of storing machine-readable instructions. As described above, the information in the user profile 902 may be correlated with merchant data or product data, thereby providing the personalized shopping channel 402 with merchants that are relevant to the particular user.

In one embodiment, the correlation may be executed by a processor located in the set top box 152, remote control unit 158, in another device coupled to the television set 154, in a head-end 306, in one or more servers in the systems shown in FIGS. 1-3, or in any suitable combination of these locations or other locations. The correlation that provides the personalized information in the personalized shopping channel 402 may be performed by software, correlation algorithms, or other machine-readable instructions stored on a machine-readable storage medium. Such correlation algorithms can be based on, in one embodiment, algorithms that are familiar to those skilled in the art or would be familiar to those skilled in the art based on the description provided herein. Several types of correlation or mapping can be performed. For instance, in an embodiment, product data can be mapped to segmentations (e.g., to geographic regions, income level, groups of users, groups of customers, and the like, alternatively or in addition to individual user profiles).

As described above, an embodiment of the personalized shopping channel 402 can display a selection of merchants as determined from the user profile 902. Alternatively or in addition, another embodiment allows the user to explicitly choose which specific merchant sites or links, television commercials, banner advertisements, and the like to display in the personalized shopping channel 402, with the displayed information not necessarily being based on the data in the user profile 902. For instance, if the user's favorite hobby is fishing, the user may explicitly customize the personalized shopping channel 402 to display merchant or product information related only to fishing, even if the user profile 902 has absolutely no information related to fishing. An embodiment allows the user to explicitly customize the personalized shopping channel 402 based on techniques analogous to designating “favorites” via a PC web browser.

FIGS. 10-12 illustrate example uses of an embodiment of the personalized shopping channel 402 for transactions that can be conducted via the interactive video casting systems of FIGS. 1-3. These figures illustrate that the merchants presented to a user on the personalized shopping channel 402 can be limited to select merchants (e.g., those most likely to generate a purchase, as determined by correlating the information in the user profile 902 with merchant data and/or product data). In FIG. 10, a web page or a broadcast segment 1002 highlights a purchase by the user at 1004 that contributes data to the user profile 902. In this instance, a user is purchasing home electronics equipment from an auction web site.

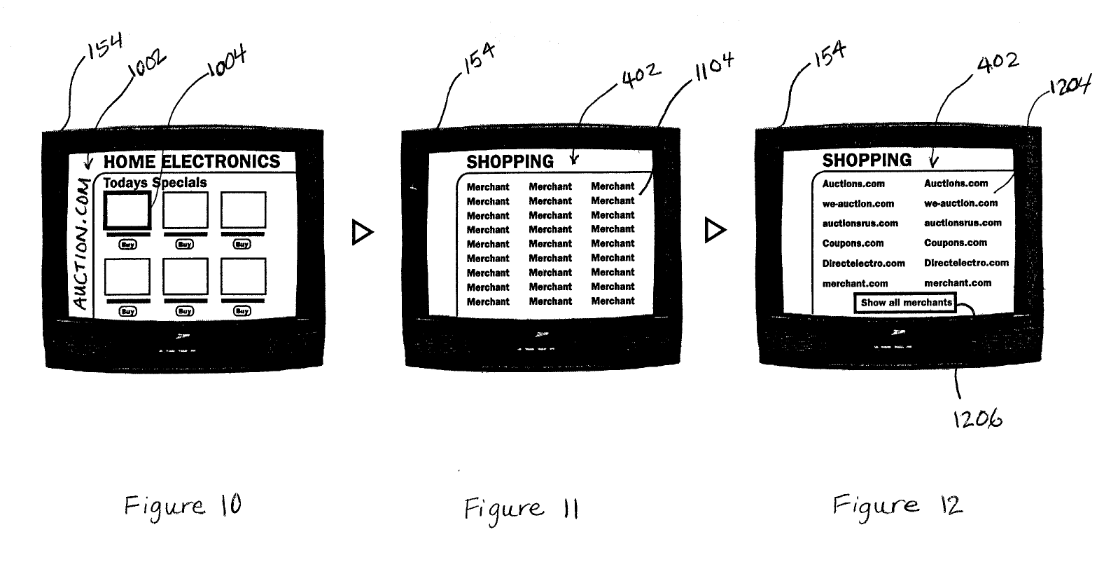

FIG. 11 shows that without correlation or user selection of merchants, a substantially unfiltered merchant list 1104 is displayed on the personalized shopping channel 402. Alternatively or in addition, FIG. 11 can also illustrate an embodiment of the invention where the personalization feature of the personalized shopping channel 402 can be toggled OFF (in this case) or ON by the user. If ON, the personalization feature is activated (e.g., so as to allow use of the user profile 902 and/or explicit customization by the user). If OFF, the personalized shopping channel 402 can provide substantially unfiltered access to all merchants.

The unfiltered merchant list 1104 can be time-consuming and cumbersome for some users to navigate through. The unfiltered merchant list 1104 may display merchants whose products are not within the user's price range, or may display merchants that do not sell the type of product the user is seeking. FIG. 12 illustrates the result when the information in the user profile 902 is correlated with merchant data, resulting in presentation of a list of a select group of merchants 1204 to the user by the personalized shopping channel 402. If, for example, the purchase 1004 in FIG. 10 (or surveys filled out by the user) indicates that the user is an impulsive buyer for high-end products, this data in the user profile 902 may be correlated with product and merchant data to produce the select group of merchants 1204. The select group of merchants 1204 are those that provide auctions or dynamic pricing, which are features that correspond to the user's impulsive buying characteristics/profile. Alternatively or in addition, the majority of offers displayed in personalized shopping channel 402, or in other channels, may be commerce offers rather than advertisements, thereby also targeting the user's impulsive buying characteristics.

In an embodiment, if the user has more than one profile, the user can select which profile is to be correlated before a merchant list is produced. Further, the merchant list 1204 can serve as a link to each merchant or to another screen where the user can indicate whether commercials or advertisements from this merchant should be displayed. FIG. 12 also shows that the user can return to the unfiltered list of merchants 1104 at any time by toggling on an indicator 1206.

Alternatively or in addition to the merchant list 1204 displayed on the personalized shopping channel 402, the user profile 902 can be correlated to commercials so that the personalized shopping channel 402 only broadcasts selected commercials to the user. As mentioned above, the cable service provider 108, the local studio 106, or other party may set up a dedicated shopping channel in one embodiment customized to each user. In another embodiment, the cable service provider 108, the local studio 106, or other party can provide customization for existing channels. For example, if an existing home shopping channel shows a commercial for jewelry or a particular type of jewelry that correlates to a user's interests, a link to a local advertisement or merchant that sells, or is offering a special for, that type of merchandise appears. The user can then link directly to a web site or television channel where the user can purchase or obtain more information about the merchandise.

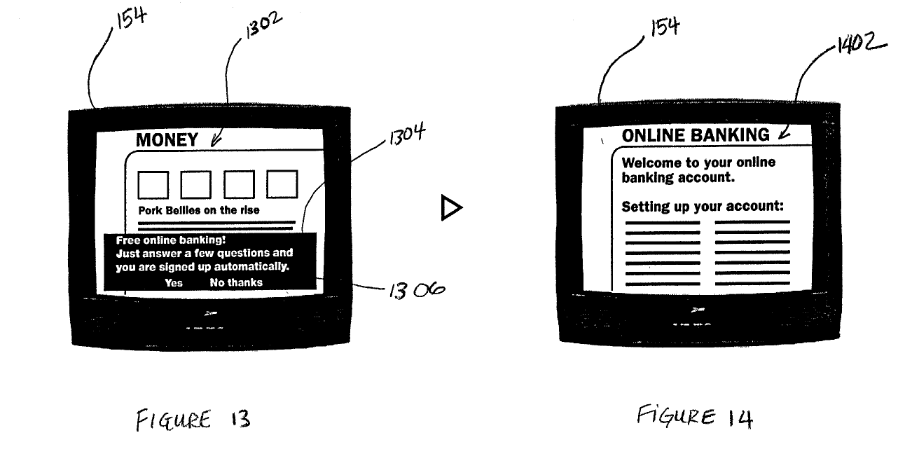

According to an embodiment, cross-selling, up-selling, or other promotional and marketing techniques can be used in conjunction with the personalized shopping channel 402. For example, FIGS. 13-14 illustrate an example of a promotion that can be provided in conjunction with the personalized shopping channel 402 to encourage users to create user profiles, to otherwise use the personalized shopping channel 402, or to conduct other commerce transactions. Such promotions allow the user to maintain the “thrill of the chase” when looking for a good bargain or for a novelty item, or is simply trying something new.

In FIG. 13, a specialized channel 1302 that relates to a user's interests, or any channel that the user may happen to be watching, is shown. In this example, the channel 1302 is a showing a program related to money and the stock market. A promotion 1304 that is consistent with the user profile 902 is then displayed on the channel 1302. For instance, the user is offered the promotion 1304 for online banking because information in the user profile 902 shows a preference or a need for convenient financial services.

The promotion 1304 may be offered even if the user has not yet created a profile. For example, if the user does not have a profile established at that point, the promotion 1304 can invite the user to personalize purchase experiences in exchange for free online banking by answering a series of questions in a questionnaire. The user is presented with a choice to accept or reject the promotion 1304 at 1306. If the user accepts the offer at 1306, then the information entered by the user in the questionnaire can be used to create the user profile 902, and the free online banking service is automatically added to the user's interactive television service or account. As FIG. 14 illustrates, if the user accepts the promotion 1304, an online banking interface 1402 (such as a web page) to allow the user to set up an online banking account appears the next time the user goes to a home banking channel or web site.

The promotion 1304 may be displayed automatically as part of the television broadcast in one embodiment. In another embodiment, the promotion 1304 may be displayed as supplemental information in response to user activation of a button on the remote control unit 158 (e.g., pressing on a button 172 or 174 on the remote control unit 158 to “click” on an icon displayed on the television set 154). In this embodiment, a first screen that displays the promotion 1304 may then appear on the television set 154. Responsive to a second click from the remote control unit 158, a second screen (such as shown in FIG. 14) may then appear to allow the user to proceed with the transaction.

In conclusion, a user may be presented with shopping sites through the personal shopping channel 402 that is provided via the interactive video casting systems shown in FIGS. 1-3. These shopping sites may be selected by correlating the user profile 902 with merchant data and/or product data, thereby providing a highly targeted “shopping trip” to the user. The user profile 902 can contain any type of information relevant to the user's purchasing habits. In another embodiment, the user may explicitly customize the content of the personalized shopping channel 402 alternatively or in addition to the correlation with the user profile 902.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
obtaining information related to a user of an interactive video casting system;
correlating the obtained user information with merchant data to associate merchants to the user; and
personalizing a shopping channel, available via the interactive video casting system, to present the merchants associated to the user, while excluding other merchants.

2. The method of claim 1 wherein the interactive video casting system comprises an interactive television system.

3. The method of claim 1 wherein the personalized shopping channel comprises a web site.

4. The method of claim 1 wherein the personalized shopping channel comprises a television channel, the method further comprising providing television programming on the television channel that presents information related to the merchants associated to the user.

5. The method of claim 4 wherein the information related to the merchants associated to the user comprises a merchant list.

6. The method of claim 4 wherein the information related to the merchants associated to the user comprises links to sites of those merchants.

7. The method of claim 1, further comprising providing user control to allow activation or deactivation of the personalization of the shopping channel, wherein deactivation of the personalization allows presentation of merchants different from the merchants associated to the user.

8. The method of claim 1, further comprising placing at least some of the obtained information related to the user in a profile, wherein correlating the obtained user information with the merchant data includes correlating the information in the profile with the merchant data.

9. The method of claim 1 wherein obtaining information related to the user includes obtaining information explicitly provided by the user.

10. The method of claim 9 wherein the information explicitly provided by the user comprises one of a survey information, poll information, profile information, calendar information, or wish list information.

11. The method of claim 1 wherein obtaining information related to the user includes obtaining implicit data related to the user.

12. The method of claim 11 wherein the implicit data includes one of a transaction history information, viewing habit information, o r click stream usage information.

13. The method of claim 1 wherein personalizing the shopping channel to present the merchants associated to the user includes presenting the merchants according to user-specified personalization of the shopping channel.

14. The method of claim 1, further comprising:
correlating the obtained user information with product data to associate products to the user; and
personalizing the shopping channel to present the products associated to the user, while excluding other products.

15. The method of claim 1, further comprising presenting a cross-sell or up-sell promotion in conjunction with presenting the merchants associated to the user in the personalized shopping channel.

16. The method of claim 1 wherein personalizing the shopping channel includes using a collaborative filter technique.

17. The method of claim 1 wherein the shopping channel is capable of being personalized according to different styles of shopping of the user.

18. The method of claim 1 wherein the shopping channel is capable of being personalized according to information related to a plurality of different users.

19. The method of claim 1, further comprising:
placing at least some of the obtained information related to the user in a plurality of different profiles;
correlating the information in the different profiles with merchant data to associate merchants to each of the different profiles; and
personalizing a plurality of shopping channels to correspond to each profile.

20. An article of manufacture, comprising:
a machine-readable medium having stored thereon instructions to:
correlate information, related to a user of an interactive video casting system, with merchant data to associate merchants to the user; and
personalize a shopping channel, available via the interactive video casting system, to present the merchants associated to the user, while excluding other merchants.

21. The article of manufacture of claim 20 wherein the instructions to correlate the information related to the user includes instructions to correlate implicit data related to the user.

22. The article of manufacture of claim 20 wherein the instructions to correlate the information related to the user includes instructions to correlate data explicitly provided by the user.

23. The article of manufacture of claim 20 wherein the machine-readable medium further includes instructions stored thereon to allow the user to access shopping sites of the merchants via the personalized shopping channel.

24. A system, comprising:
an interactive video casting network coupleable to a communication network to provide a shopping channel to a user; and
a server coupleable to the interactive video casting network, the server including:
a storage unit having merchant data stored therein capable of being correlated to information obtained from and related to the user;
a processor communicatively coupled to the storage unit, the processor capable to trigger correlation of the merchant data in the storage unit to the information related to the user to associate merchants to the user, and to trigger personalization of the shopping channel to present the merchants associated to the user along with exclusion of other merchants; and
a communication interface communicatively coupled to the processor to provide the personalized shopping channel to a client terminal of the user.

25. The system of claim 24 wherein the interactive video casting network comprises an interactive television network.

26. The system of claim 24, further comprising another storage unit capable to store the information related to the user.

27. The system of claim 26 wherein the information related to the user is explicitly provided by the user to the interactive video casting network or to the communication network, via the client terminal.

28. The system of claim 26 wherein the information related to the user includes implicit data related to user transactions with the interactive video casting network or with the communication network.

29. The system of claim 24 wherein the personalized shopping channel includes links to sites of the merchants associated to the user, the merchant sites communicatively coupleable to the video casting network via the communication network.

30. The system of claim 26 wherein the personalized shopping channel is capable to provide television programming, associated to the user based on the correlation of the user information to the merchant data, to the client terminal, wherein the television programming includes product supplemental information corresponding to the merchants associated to the user.

31. A method, comprising:
obtaining information related to a user of an interactive video casting system;
personalizing a shopping channel available via the interactive video casting system, based on the obtained information related to the user, to present merchants associated to the user, while excluding other merchants;
responsive to a first command received from a user input device, presenting supplemental information related to one of the merchants presented in the personalized shopping channel; and
responsive to a second command received from the user input device, initiating a transaction related to the supplemental information presented in the personalized shopping channel.

32. The method of claim 31 wherein the supplemental information is presented in a first screen, and wherein the transaction is initiated in a second screen.

33. The method of claim 32 wherein the supplemental information presented in the first screen includes advertising information.
